(19) United States
(12) Patent Application Publication
(10) Pub. No.: US 2025/0318036 A1
(43) Pub. Date: Oct. 9, 2025

(54) OBTAINING LOCATIONS OF LIGHT SOURCES OF A LIGHT STRING WRAPPED AROUND AN OBJECT

(71) Applicant: SIGNIFY HOLDING B.V., EINDHOVEN (NL)

(72) Inventors: JAN EKKEL, OSS (NL); DZMITRY VIKTOROVICH ALIAKSEYEU, EINDHOVEN (NL)

(21) Appl. No.: 18/866,714

(22) PCT Filed: May 8, 2023
(86) PCT No.: PCT/EP2023/062099

§ 371 Date: Nov. 18, 2024

(30) Foreign Application Priority Data
May 17, 2022 (EP) 22173688.7

(51) Int. Cl. H05B 47/175; H05B 47/155

(52) U.S. Cl. CPC H05B 47/1985; H05B 47/155

(57) ABSTRACT

A method of controlling a string of light sources wrapped around an object comprises obtaining (101) a user input signal specifying a number of turns with which the string has been wrapped around the object, obtaining (103) information indicative of a quantity of the light sources, a spacing between the light sources, and a basic shape of the object, determining (105) a location of each of the light sources based on the number of turns, the quantity of the light sources, the spacing between the light sources, and the basic shape of the object, determining (107) a light setting for each of the light sources based on the locations of the light sources, and controlling (109) the string of light sources according to the light settings.

### FIELD OF THE INVENTION

The invention relates to a system for controlling a string of light sources wrapped around an object.

The invention further relates to a method of controlling a string of light sources wrapped around an object.

The invention also relates to a computer program product enabling a computer system to perform such a method.

### BACKGROUND OF THE INVENTION

For creating meaningful light effects for a light string wrapped around an object, e.g., a Christmas tree, it is important to know the locations of the individual light sources. Without knowing the locations of the individual light sources, it is impossible to create meaningful light effects that involve multiple light sources that are not adjacent in the light string. For example, for a falling star light effect, the locations of the individual light sources are required to be able to select appropriate light sources.

WO 2018224390 A1 discloses an electronic device is configured to obtain information identifying available light sources, including their positions. The electronic device is further configured to receive an instruction to render a light effect. The instruction comprises one or more light effect parameters, a mapping function identifier and one or more spatial indications. The electronic device is further configured to map the light effect to one or more of the available light sources based on the one or more light effect parameters, the mapping function identifier, the one or more spatial indications and the positions of the available light sources.

A known way of determining the locations of the individual light sources is by using a camera. For example, US 2019/261485 A1 discloses a lighting system which comprises a control unit that activates each light source of the light string according a respective switching-on sequence. A user device comprises a camera that acquires a sequences of images of the surrounding environment and analyzes this sequence to determine the spatial position and/or identification code of each light source.

However, a drawback of camera-based implementations is that a camera may not always be available and camera-based implementations are often not trivial to use, especially in spaces with reflective surfaces.

### SUMMARY OF THE INVENTION

It is a first object of the invention to provide a system, which can be used to determine locations of light sources on a string wrapped around an object without needing a camera and control these light sources based on these locations.

It is a second object of the invention to provide a method, which can be used to determine locations of light sources on a string wrapped around an object without needing a camera and control these light sources based on these locations.

In a first aspect of the invention, a system for controlling a string of light sources wrapped around an object comprises at least one input interface, at least one output interface, and at least one processor configured to obtain, via said at least one input interface, a user input signal specifying a number of turns with which said string has been wrapped around said object, obtain information indicative of a quantity of said light sources, a spacing between said light sources, and a basic shape of said object, determine a location of each of said light sources based on said number of turns, said quantity of said light sources, said spacing between said light sources, and said basic shape of said object, determine a light setting for each of said light sources based on said locations of said light sources, and control, via said at least one output interface, said string of light sources according to said light settings.

By letting the user specify the number of turns with which the light string has been wrapped around the object, e.g. a Christmas tree, and combining this information with the quantity of light sources on the string, the spacing between the light sources on the string, and the basic shape of the object, locations of the light sources can be determined in a manner which is simple for the user and does not require a camera. The user input signal may be further indicative of the basic shape of the object. Alternatively, the basic shape of the object may be pre-defined. For example, the basic shape of the object may be a cone, a cylinder or a cube.

Information indicative of the quantity of light sources on the string and the spacing between the light sources may be part of the user input signal. Alternatively, said at least one processor may be configured, for example, to obtain, via said at least one input interface, part of said information from said string, said part of said information being indicative of said quantity of said light sources and said spacing between said light sources.

Said information may specify a type of said string and said at least one processor may be configured to determine said quantity of said light sources and said spacing between said light sources based on said type of said string. For example, the length of the string and the spacing are typically defined by the product type which, in a smart lighting system, is known to most of the smart components in the system. For instance, in the Philips Hue system, the Philips Hue bridge and the smart phone Hue application know the product type and firmware release of each of the lamps and accessories.

Said information may be further indicative of a starting position of said string and said at least one processor may be configured to determine said location of each of said light sources further based on said starting position, said starting position indicating whether said string has been wrapped around said object starting from a first end of said object or starting from a second end of said object. Use of the correct starting position is important for certain shapes like cones where less string is normally wrapped around one part of the object than around a second part of the object. The first end may be a top of the object and the second end may a bottom of the object for a first shape of the object, for example. The first end may be a left end of the object and the second end may be a right end of the object for a second shape of the object, for example.

Said user input signal may be indicative of said starting position. For example, the user may specify “starts at top” or “starts at bottom”. Alternatively, a certain starting position may be assumed. For example, most people start wrapping a light string around their Christmas tree starting from the bottom, because they connect their light string to a power socket at the bottom of a wall, so for a Christmas tree, a starting position at the bottom of the object might be assumed.

Said information may be further indicative of a width of said object and said at least one processor may be configured to determine said location of each of said light sources further based on said width of said object. This information may be used to increase the accuracy of the estimated locations. Said user input signal may be indicative of said width of said object, for example. For instance, the user may be asked whether the object, e.g. a cone, is small, normal, or wide or may be requested to specify a width in centimeters or inches (e.g. of the base of a cone). Alternatively, said width of said object may have been pre-defined, for example.

Said user input signal may be further indicative of a wrapping direction of said string around said object and said at least one processor may be configured to determine said light setting for each of said light sources further based on said wrapping direction, said wrapping direction being clockwise or counter clockwise. Knowledge of the wrapping direction may be beneficial for certain light effects, e.g. a light effect that moves from the left to the right of the object.

Said information may be further indicative of a height of said object and said at least one processor may be configured to determine whether said height matches said number of turns, if said height and said number of turns do not match, ask a user to provide further user input indicative of whether said string is wrapped with a higher number of turns around a top half of said object or around a bottom half of said object, and determine said location of each of said light sources further based on said further user input.

In most cases, people wrap the light string around the entire object. In this case, it would be possible to calculate the object height that matches the number of turns based on the basic shape of the object and the length of the light string. However, if people do not wrap the light string around the entire object, then this object height would not be correct. By asking a user to specify both the number of turns and indicate the height of the object, it may be determined whether they match. If they do not match, the user may be asked to provide further user input indicative of whether the string is wrapped with a higher number of turns around a top half of the object or around a bottom half of the object in order to determine the locations of the light sources more accurately. The user may indicate the height by interacting with a visual representation of the object, for example. The user may be able to indicate the width of the object in the same way.

Said at least one processor may be configured to determine said light setting for each of said light sources based on said locations of said light sources such that a user is able to perceive a border between light sources wrapped around a top portion of said object and light sources wrapped around a bottom portion of said object, control, via said at least one output interface, said string of light sources according to said light settings, ask a user to provide first feedback indicative of whether said border corresponds to a horizontal centerline of said object, determine an adjusted location of each of said light sources based on said number of turns, said quantity of said light sources, said spacing between said light sources, said basic shape of said object, and said first feedback, determine a further light setting for each of said light sources based on said adjusted locations of said light sources, and control, via said at least one output interface, said string of light sources according to said further light settings.

This may be used as alternative to asking the user to indicate the width of the object or may be used to check whether the user has indicated the correct width. The border may be created by controlling a first part of the light string with one color and a last part of the light string with another color, for example. For instance, the light string may be controlled to render two colors. Alternatively or additionally, the border may be created by controlling a set of adjacent light sources expected to be wrapped around the middle of the object with one color and other light sources with one or more other colors, for example. For instance, light sources of a single turn may be controlled to render a first color and the other light sources may be controlled to render a second color.

Said at least one processor may be configured to determine said light setting for each of said light sources based on said locations of said light sources such that light sources located on a first side of said object render a first color and light sources located on a second side of said object render a second color, control, via said at least one output interface, said string of light sources according to said light settings, ask a user to provide second feedback indicative of a side of said object at which said first color is being rendered, said side being one of a left side, a right side, a front side, and a back side, determine a further light setting for each of said light sources based on said locations of said light sources and said second feedback, and control, via said at least one output interface, said string of light sources according to said further light settings.

This is beneficial, for example, when the object is placed in a corner and some of the light sources are not visible to anyone. In this case, light effects may be adapted based on which light sources are not visible to anyone.

In a second aspect of the invention, a method of controlling a string of light sources wrapped around an object comprises obtaining a user input signal specifying a number of turns with which said string has been wrapped around said object, obtaining information indicative of a quantity of said light sources, a spacing between said light sources, and a basic shape of said object, determining a location of each of said light sources based on said number of turns, said quantity of said light sources, said spacing between said light sources, and said basic shape of said object, determining a light setting for each of said light sources based on said locations of said light sources, and controlling said string of light sources according to said light settings. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling a string of light sources wrapped around an object.

The executable operations comprise obtaining a user input signal specifying a number of turns with which said string has been wrapped around said object, obtaining information indicative of a quantity of said light sources, a spacing between said light sources, and a basic shape of said object, determining a location of each of said light sources based on said number of turns, said quantity of said light sources, said spacing between said light sources, and said basic shape of said object, determining a light setting for each of said light sources based on said locations of said light sources, and controlling said string of light sources according to said light settings.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java (TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 shows two differently shaped objects with different numbers of turns;

FIG. 3 shows an example of a user interface for inputting a number of turns and selecting an object width;

FIG. 4 is a block diagram of a second embodiment of the system;

FIG. 5 is a flow diagram of a first embodiment of the method;

FIG. 6 is a flow diagram of a second embodiment of the method;

FIG. 7 is a flow diagram of a third embodiment of the method;

FIG. 8 shows examples of an illuminated object representation displayed when asking for feedback in the method of FIG. 7;

FIG. 9 is a flow diagram of a fourth embodiment of the method;

FIG. 10 is a flow diagram of a fifth embodiment of the method; and

FIG. 11 is a block diagram of an exemplary data processing system for performing the method of the invention.

Corresponding elements in the drawings are denoted by the same reference numeral.

### DETAILED DESCRIPTION OF THE EMBODIMENTS

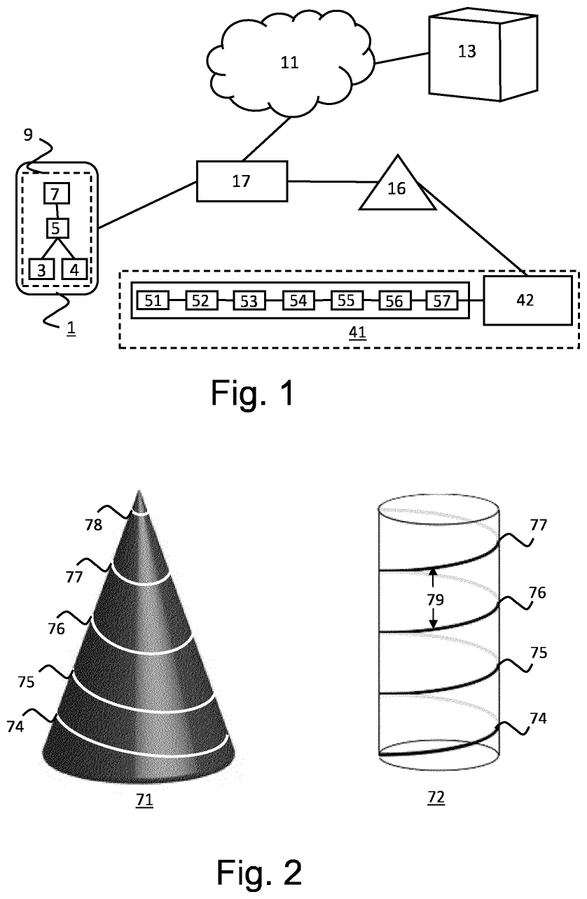

FIG. 1 shows a first embodiment of the system for controlling a string of light sources wrapped around an object. In this first embodiment, the system is a mobile device 1. In the example of FIG. 1, the string of light sources is a light string 41 comprising a controller 42 and light sources 51-57. The light sources 51-57 may each comprise one or more LEDs, for example. In the example of FIG. 1, for the sake of simplicity, the light string 41 has only seven light sources. In practice, light strings will typically have many more light sources. The object has a regular shape and may be a Christmas tree, for example. The light sources 51-57 can be controlled individually. Thus, different light sources of the light string 41 may have different light settings (on/off, color, intensity).

Mobile device 1 is able to control light sources 51-57 of light string 41 via a wireless LAN access point 17 and a bridge 16, and optionally via an Internet server 13, e.g. of the manufacturer of the light string 41. The light string 41 communicates with the bridge 16, e.g. using Zigbee technology. The bridge 16 may be a Philips Hue bridge, for example. The bridge 16 is connected to the wireless LAN access point 17, e.g. via Wi-Fi or Ethernet.

The mobile device 1 comprises a receiver 3, a transmitter 4, a processor 5, memory 7, and a touchscreen display 9. The processor 5 is configured to obtain, via the touchscreen display 9, a user input signal specifying a number of turns with which the string 41 has been wrapped around the object, obtain information indicative of a quantity of the light sources in the light string 41, a spacing between the light sources 51-57, and a basic shape of the object, determine a location of each of the light sources 51-57 based on the number of turns, the quantity of the light sources in the light string 41, the spacing between the light sources 51-57, and the basic shape of the object, determine a light setting for each of the light sources 51-57 based on the locations of the light sources 51-57, and control, via the transmitter 4, the string 41 according to the light settings.

The processor 5 may be configured to obtain, via the receiver 3, from the string 41, part of the information which is indicative of the quantity of the light sources on the light string 41 and the spacing between the light sources 51-57. This part of the information may specify the quantity of light sources and the light spacing or may specify a type of the string. In the latter case, the processor 5 may be configured to determine the quantity of light sources and the light spacing based on the type of the string, e.g. by consulting Internet server 13. Alternatively, a user may use touchscreen display 9 to input the quantity of light sources and the light spacing or input the type of the string. The type of the string is normally a unique product type.

The basic shape of the object may be a cone, a cylinder or a cube, for example. FIG. 2 shows two different shapes with a different number of turns. Cone 71 has five turns 74-78 and cylinder 72 has four turns 74-77.

The processor 5 may be configured to obtain a width of the object from the user input signal and determine the location of each of the light sources 51-57 further based on the width of the object. The user input signal may be indicative of the width of the object, for example. For instance, the user may be asked whether the object, e.g. a cone, is small, normal, or wide or may be requested to specify a width in centimeters or inches (e.g. a width of the base of a cone or a diameter of a cylinder). Alternatively, the processor 5 may be configured to obtain a predefined width as width of the object. The width of the object may be used to increase the accuracy of the estimated locations.

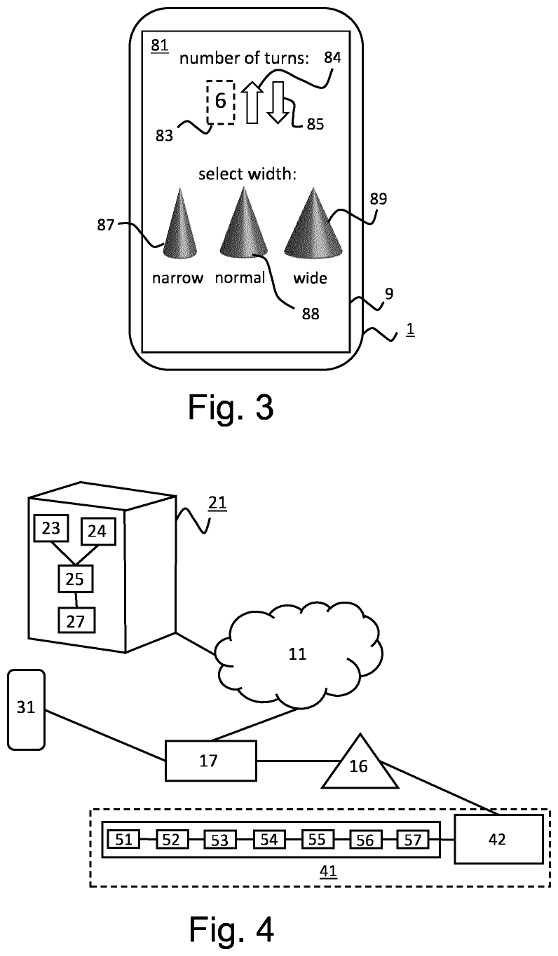

FIG. 3 shows an example of a user interface for inputting a number of turns and selecting an object width. The user interface 81 is displayed on screen 9 of the mobile device 1 of FIG. 1. The user first selects the number of turns with which the light string has been wrapped around the object using the arrow up key 84 and/or the arrow down key 85. The input number of turns, currently 6, is shown in field 83. This number of turns is confirmed when the user selects one of icons 87-89 to select the width of the object. In the example of FIG. 3, the entered number of turns is an integer number. Alternatively, the number of turns may be entered, for example, as a real number, i.e. an integer number or a decimal number (e.g. 6.5).

In the example of FIG. 3, the estimated location of the individual light sources 51-57 is improved by letting the user select the width, i.e. the ratio of the width and height of the shape. In the example of FIG. 3, the object is a cone. The icons 87-89 represent different cone shape ratios. Icon 87 represents a narrow cone, icon 88 represents a normal cone, and icon 89 represents a wide cone. Similar selection may be presented for other shapes, such as a cylinder. To further fine-tune the estimated location of the individual light sources, the user may be given full control over the shape ratio: by dragging the base and height of the shape the commissioning may be finalized.

In an example use case, the user has decorated a Christmas tree with the light string 41. For commissioning, a mobile phone application is installed on the mobile device 1. The user connects to the light string 41 with the mobile phone application, e.g., through bridge 16, and commissions the light string 41 by indicating that the basic shape is a cone and by specifying the number of turns used to decorate the tree, e.g., 6. An algorithm running on mobile device 1 (or running in the cloud or on a bridge in an alternative embodiment) calculates an estimated location for each of the light sources 51-57 on the light string 41. Effects applied to the light sources on the string use the locations of the individual light sources to map light effects to the correct locations.

If the processor 5 receives information from the bridge 16 indicating that the light string has a length of 14 meters and 280 light sources, the processor 5 calculates that the light string has a spacing of 5 centimeters between light sources. After the processor 5 determines that the basic shape of the object is a cone, e.g. because the light string or the software application is specifically made for Christmas trees, and that the user has specified that light string is wrapped around the object with six turns and the object has a normal width, the processor 5 estimates the locations of the individual light sources. In the embodiment of FIG. 1, the processor 5 assumes that the light string has been wrapped around the entire object and assumes a starting position at the bottom of the object.

In an implementation, the processor 5 obtains, e.g., by using a lookup table, a vertical distance between vertically adjacent sections of the light string, e.g. vertical distance 79 in FIG. 2, based on the determined light string length, the object width indicated by the user, and the number of turns specified by the user. For example, with a light string of 14 meters, six turns, and a normal object width (i.e. a normal height to width ratio), a vertical distance of 0.35 meters might be obtained, e.g. corresponding roughly to an object height of 2.1 meters and an object width of 1.25 meters. With a light string of 14 meters, five turns, and a normal object width, a vertical distance of 0.5 meters might be obtained, e.g. corresponding roughly to an object height of 2.45 meters and an object width of 1.45 meters. With a light string of 14 meters, seven turns, and a normal object width, a vertical distance of 0.25 meters might be obtained, e.g. corresponding roughly to an object height of 1.9 meters and an object width of 1.15 meters.

The processor 5 then estimates the locations of the individual light sources based on the light spacing between adjacent light sources and the vertical distance between vertically adjacent sections of the light string. For example, if the number of turns is six, of the 280 light sources, it may be assumed that there are 55 light sources between two light sources with approximately the same horizontal position on vertically adjacent sections of the light string. If the vertical distance is 0.35 meters, each next adjacent light source may be assumed to be located roughly 0.6 centimeters (0.35 meters/55) higher than the previous light source. As mentioned above, the distance between two adjacent light sources (i.e. the light spacing) is 5 centimeters in this example.

In the above example, the spacing between adjacent light sources is equal for each pair of adjacent light sources. However, it is not required that the spacing between adjacent light sources is equal for each pair of adjacent light sources. This would not change the algorithm much; each spacing could be considered instead of just one spacing. In the embodiment of the mobile device 1 shown in FIG. 1, the mobile device 1 comprises one processor 5. In an alternative embodiment, the mobile device 1 comprises multiple processors. The processor 5 of the mobile device 1 may be a general-purpose processor, e.g. from ARM or Qualcomm or an application-specific processor. The processor 5 of the mobile device 1 may run an Android or iOS operating system for example. The display 9 may comprise an LCD or OLED display panel, for example. The processor 5 may use touch screen display 9 to provide a user interface, for example. The memory 7 may comprise one or more memory units. The memory 7 may comprise solid state memory, for example.

The receiver 3 and the transmitter 4 may use one or more wireless communication technologies, e.g. Wi-Fi (IEEE 802.11) for communicating with the wireless LAN access point 17, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The mobile device 1 may comprise other components typical for a mobile device such as a battery and a power connector. The invention may be implemented using a computer program running on one or more processors.

In the embodiment of FIG. 1, the light string 41 is controlled by the mobile device 1 via the bridge 16. In an alternative embodiment, the light string 41 is controlled by the mobile device 1 without a bridge, e.g. directly via Bluetooth or via the wireless LAN access point 17. Optionally, the light string 41 is controlled via the cloud, e.g. via Internet server 13. The light string 41 may be capable of receiving and transmitting Wi-Fi signals, for example.

FIG. 4 shows a second embodiment of the system for controlling a string of light sources wrapped around an object. In this second embodiment, the system is a computer 21. The computer 21 is connected to the Internet 11 and acts as a server. The computer 21 may be operated by a lighting company, for example. In the embodiment of FIG. 4, the computer 21 is able to control the light string 41 via the wireless LAN access point 17 and the bridge 16.

The computer 21 comprises a receiver 23, a transmitter 24, a processor 25, and storage means 27. The processor 25 is configured to obtain, via the receiver 23, a user input signal specifying a number of turns with which the string 41 has been wrapped around the object. In the example of FIG. 4, the user input signal is received from a mobile device 31. The user input signal may be transmitted by mobile device 31 in response to interaction of a user with a touchscreen display of the mobile device 31 or in response to voice interaction by the user with the mobile device 31, for example.

The processor 25 is further configured to obtain information indicative of a quantity of the light sources in the light string 41, a spacing between the light sources 51-57, and a basic shape of the object, determine a location of each of the light sources 51-57 based on the number of turns, the quantity of the light sources in the light string 41, the spacing between the light sources 51-57, and the basic shape of the object, determine a light setting for each of the light sources 51-57 based on the locations of the light sources 51-57, and control, via the transmitter 24, the string 41 according to the light settings.

In the embodiment of the computer 21 shown in FIG. 4, the computer 21 comprises one processor 25. In an alternative embodiment, the computer 21 comprises multiple processors. The processor 25 of the computer 21 may be a general-purpose processor, e.g. from Intel or AMD, or an application-specific processor. The processor 25 of the computer 21 may run a Windows or Unix-based operating system for example. The storage means 27 may comprise one or more memory units. The storage means 27 may comprise one or more hard disks and/or solid-state memory, for example. The storage means 27 may be used to store an operating system, applications and application data, for example.

The receiver 23 and the transmitter 24 may use one or more wired and/or wireless communication technologies such as Ethernet and/or Wi-Fi (IEEE 802.11) to communicate with the wireless LAN access point 17, for example. In an alternative embodiment, multiple receivers and/or multiple transmitters are used instead of a single receiver and a single transmitter. In the embodiment shown in FIG. 4, a separate receiver and a separate transmitter are used. In an alternative embodiment, the receiver 23 and the transmitter 24 are combined into a transceiver. The computer 21 may comprise other components typical for a computer such as a power connector. The invention may be implemented using a computer program running on one or more processors.

In the embodiment of FIG. 4, the computer 21 receives data from and transmits data to the light string 41 via the bridge 16. In an alternative embodiment, the computer 21 receives data from and transmits data to the light string 41 without a bridge.

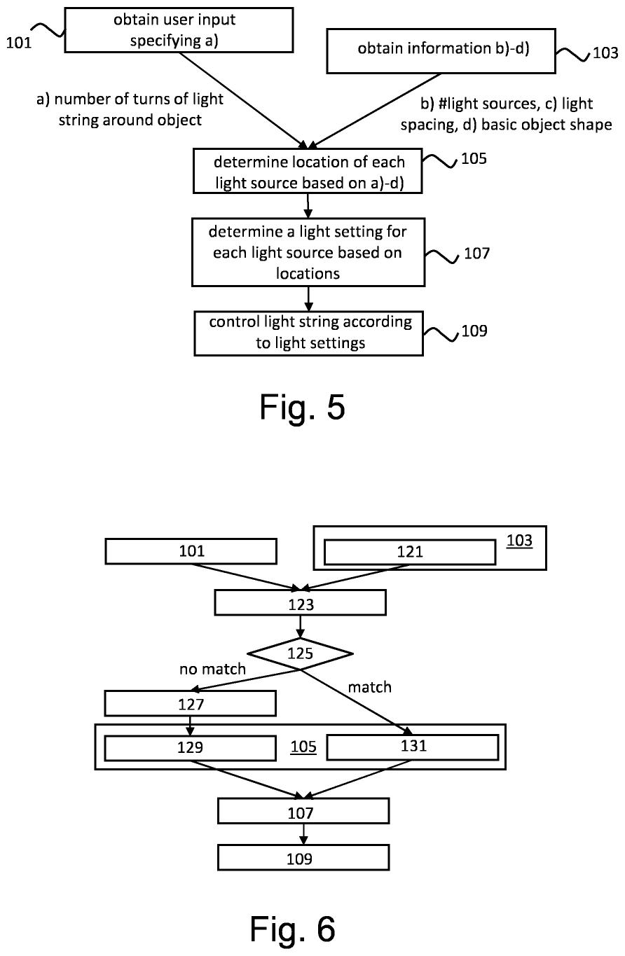

A first embodiment of the method of controlling a string of light sources wrapped around an object is shown in FIG. 5. The method may be performed by mobile device 1 of FIG. 1 or cloud computer 21 of FIG. 4, for example.

A step 101 comprises obtaining a user input signal specifying a number of turns with which the string has been wrapped around the object. A step 103 comprises obtaining information indicative of a quantity of the light sources, a spacing between the light sources, and a basic shape of the object. Some or all of the information obtained in step 103 may be obtained from the user input signal obtained in step 101. For example, the user input signal may be further indicative of the basic shape of the object and the basic shape of the object may be obtained from the user input signal in step 103. Optionally, step 103 is performed only after step 101 has been completed or steps 101 and 103 are combined into a single step.

A step 105 comprises determining a location of each of the light sources based on the number of turns, the quantity of the light sources, the spacing between the light sources, and the basic shape of the object. A step 107 comprises determining a light setting for each of the light sources based on the locations of the light sources determined in step 105. A step 109 comprises controlling the string of light sources according to the light settings determined in step 107.

A second embodiment of the method of controlling a string of light sources wrapped around an object is shown in FIG. 6. The second embodiment of FIG. 6 is an extension of the first embodiment of FIG. 5. In the embodiment of FIG. 6, step 103 of FIG. 5 is implemented by a step 121 and step 105 of FIG. 5 is implemented by steps 129 and 131.

Step 101 comprises obtaining a user input signal specifying a number of turns with which the string has been wrapped around the object. Step 121 comprises obtaining information indicative of a quantity of the light sources, a spacing between the light sources, and a basic shape of the object. In the embodiment of FIG. 6, the information obtained in step 121 is further indicative of a height of the object.

Some or all of the information obtained in step 121 may be obtained from the user input signal obtained in step 101. As a first example, the user input signal may be further indicative of the basic shape of the object and the basic shape of the object may obtained from the user input signal in step 121. As a second example, the user input signal may be further indicative of the height of the object and the height of the object may obtained from the user input signal in step 121.

A step 123 comprises determining a matching level between the height indicated by the user and the number of turns indicated by the user. A step 125 comprises determining whether the height matches the number of turns. It is determined in step 125 that there is a match if the matching level determined in step 123 exceeds a certain threshold, e.g. 80%. Step 131 is performed if there is a match and step 127 is performed if there is no match. Step 131 comprises determining a location of each of the light sources based on the number of turns, the quantity of the light sources, the spacing between the light sources, and the basic shape of the object.

Step 127 comprises asking a user to provide further user input indicative of whether the string is wrapped with a higher number of turns around a top half of the object or around a bottom half of the object. For example, if the number of turns does not coincide with the object height (e.g. based on the estimation, the number of turns looks either too many or too few), the user may be asked to clarify if the light string was only wrapped around top of the tree (higher number of turns), bottom (lower number of turns), or center.

Next, step 129 comprises determining a location of each of the light sources based on the number of turns, the quantity of the light sources, the spacing between the light sources, and the basic shape of the object, and further based on the further user input received in step 127. Step 107 is performed after step 129 or 131 has been performed. Step 107 comprises determining a light setting for each of the light sources based on the locations of the light sources determined in step 105. Step 109 comprises controlling the string of light sources according to the light settings determined in step 107.

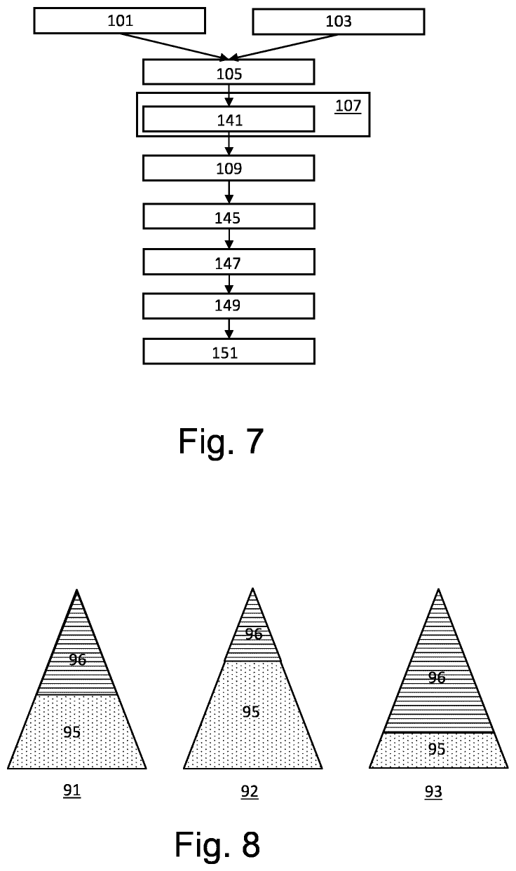

A third embodiment of the method of controlling a string of light sources wrapped around an object is shown in FIG. 7. The third embodiment of FIG. 7 is an extension of the first embodiment of FIG. 5. In the embodiment of FIG. 7, step 107 of FIG. 5 is implemented by a step 141.

Step 101 comprises obtaining a user input signal specifying a number of turns with which the string has been wrapped around the object. Step 103 comprises obtaining information indicative of a quantity of the light sources, a spacing between the light sources, and a basic shape of the object. Some or all of the information obtained in step 103 may be obtained from the user input signal obtained in step 101. For example, the user input signal may be further indicative of the basic shape of the object and the basic shape of the object may obtained from the user input signal in step 103.

Step 105 comprises determining a location of each of the light sources based on the number of turns, the quantity of the light sources, the spacing between the light sources, and the basic shape of the object. Step 141 comprises determining the light setting for each of the light sources based on the locations of the light sources determined in step 105 such that a user is able to perceive a border between light sources wrapped around a top portion of the object and light sources wrapped around a bottom portion of the object. Step 109 comprises controlling the string of light sources according to the light settings determined in step 141.

Step 145 comprises asking a user to provide first feedback indicative of whether the border corresponds to a horizontal centerline of the object. FIG. 8 shows examples of an illuminated object representation displayed when asking for feedback. In the implementation to which these examples relate, two colors are displayed after the commissioning such that the border between the colors should be around the middle (i.e. the horizontal centerline) of the object. The user may then be asked to specify whether the border is in the middle, above, or below.

These three options 91-93 are represented graphically in the examples of FIG. 8. Light sources on a first part of the light string are controlled to render a first color 95 and this color 95 is visually represented in options 91-93. Light sources on a last part of the light string are controlled to render a second color 96 and this color 96 is also visually represented in options 91-93. Which part of the light string is controlled with which color has been determined based on the locations determined in step 105.

In first option 91, the border is in the middle of the object. If this option matches the illumination of the real object, this means that the part of the light string that has been wrapped around the bottom half of the object is as large as expected, e.g. because the width of the object matches the assumed or indicated width. In second option 92, the border is above the middle of the object. If this option matches the illumination of the real object, this means that the part of the light string that has been wrapped around the bottom half of the object is smaller than expected, e.g. because the width of the object is smaller than assumed or indicated.

In third option 93, the border is below the middle of the object. If this option matches the illumination of the real object, this means that the part of the light string that has been wrapped around the bottom half of the object is larger than expected, e.g. because the width of the object is larger than assumed or indicated. The user is able to select the option that matches what the user is seeing with respect to the real object. In an alternative implementation, three colors are used instead of two colors and/or the user is able to select the appropriate option without a visual representation, e.g. by using a voice assistant.

Step 147 comprises determining an adjusted location of each of the light sources based on the number of turns, the quantity of the light sources, the spacing between the light sources, the basic shape of the object, and the first feedback received in step 145. Step 149 comprises determining a further light setting for each of the light sources based on the adjusted locations of the light sources determined in step 147. Step 151 comprises controlling the string of light sources according to the further light settings determined in step 149.

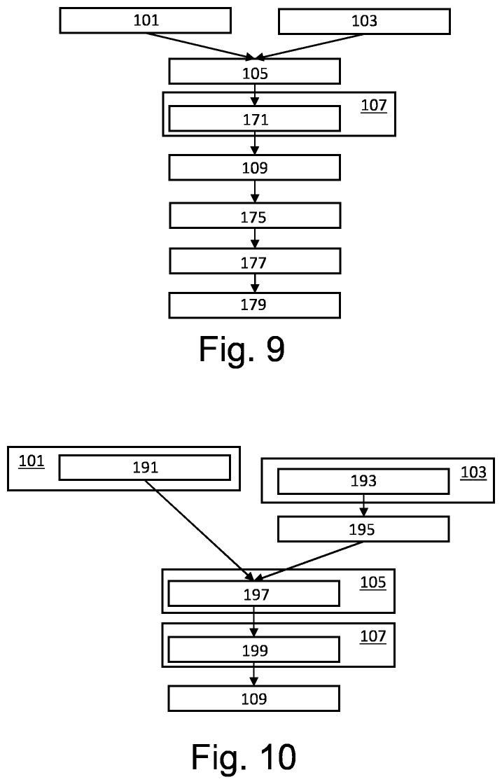

A fourth embodiment of the method of controlling a string of light sources wrapped around an object is shown in FIG. 9. The fourth embodiment of FIG. 9 is an extension of the first embodiment of FIG. 5. In the embodiment of FIG. 9, step 107 of FIG. 5 is implemented by a step 171.

Step 101 comprises obtaining a user input signal specifying a number of turns with which the string has been wrapped around the object. Step 103 comprises obtaining information indicative of a quantity of the light sources, a spacing between the light sources, and a basic shape of the object. Some or all of the information obtained in step 103 may be obtained from the user input signal obtained in step 101. For example, the user input signal may be further indicative of the basic shape of the object and the basic shape of the object may obtained from the user input signal in step 103.

Step 105 comprises determining a location of each of the light sources based on the number of turns, the quantity of the light sources, the spacing between the light sources, and the basic shape of the object. Step 171 comprises determining a light setting for each of the light sources based on the locations of the light sources determined in step 105 such that light sources located on a first side of the object render a first color and light sources located on a second side of the object render a second color. Step 109 comprises controlling the string of light sources according to the light settings determined in step 171.

Step 175 comprises asking a user to provide second feedback indicative of a side of the object at which the first color is being rendered, the side being one of a left side, a right side, a front side, and a back side. As a first example, the user may be asked to indicate whether the color blue is rendered on the front side or on the back side. As a second example, the user may be asked to indicate whether the color blue is rendered on the left side, the right side, the front side, or the back side. As a third example, the user may be asked to indicate whether the color blue is rendered the most on the left-front, left-back, right-front, or right-back. As a fourth example, the user may be asked a few of these question in a sequence, wherein visualization on the string of lights changes after each question/answer (and depending on each answer).

In one implementation, a plurality of visual representations is displayed and the user is asked to select one of these visual representations. These representations may look like the representation of FIG. 8, but with a vertical border instead of a horizontal border. Step 177 comprises determining a further light setting for each of the light sources based on the locations of the light sources and the second feedback received in step 175. Step 179 comprises controlling the string of light sources according to the further light settings determined in step 177.

A fifth embodiment of the method of controlling a string of light sources wrapped around an object is shown in FIG. 10. The fifth embodiment of FIG. 10 is an extension of the first embodiment of FIG. 5. In the embodiment of FIG. 10, steps 101, 103, 105, and 107 of FIG. 5 are implemented by steps 191, 193, 197, and 199, respectively.

Step 191 comprises obtaining a user input signal specifying a number of turns with which the string has been wrapped around the object. the embodiment of FIG. 10, the user input signal obtained in step 191 is further indicative of a wrapping direction of the string around the object. This wrapping direction is clockwise or counter clockwise.

Step 193 comprises obtaining information indicative of a quantity of the light sources, a spacing between the light sources, and a basic shape of the object. In the embodiment of FIG. 10, the information obtained in step 193 specifies a type of the string. The type of the string is indicative of the quantity of the light sources and the spacing between the light sources. In the embodiment of FIG. 10, the information obtained in step 193 is further indicative of a starting position of the string and/or a width of the object. The starting position indicates whether the string has been wrapped around the object starting from a first end, e.g. top, of the object or starting from a second end, e.g. bottom, of the object.

Some or all of the information obtained in step 193 may be obtained from the user input signal obtained in step 191. As a first example, the user input signal may be further indicative of the basic shape of the object and the basic shape of the object may obtained from the user input signal in step 193. As a second example, the user input signal may be further indicative of the starting position and the starting position may obtained from the user input signal in step 193. As a third example, the user input signal may be further indicative of the width of the object and the width of the object may obtained from the user input signal in step 193. Alternatively, the width of the object may have been pre-defined. Optionally, step 193 is performed only after step 191 has been completed or steps 191 and 193 are combined into a single step.

Step 195 comprises determining the quantity of the light sources and the spacing between the light sources based on the type of the string indicated in the information obtained in step 193. Step 197 comprises determining a location of each of the light sources based on the number of turns, the quantity of the light sources, the spacing between the light sources, and the basic shape of the object, and further based on the starting position and/or the width of the object.

Step 199 comprises determining a light setting for each of the light sources based on the locations of the light sources determined in step 197 and optionally further based on the wrapping direction indicated in the user input signal obtained in step 191, e.g. depending on the light effect to be rendered. Step 109 comprises controlling the string of light sources according to the light settings determined in step 199.

The embodiments of FIGS. 5-7 and 9-10 differ from each other in multiple aspects, i.e. multiple steps have been added or replaced. In variations on these embodiments, only a subset of these steps is added or replaced and/or one or more steps is omitted. As a first example, steps 191 and 199 of the fifth embodiment of FIG. 10 may be omitted from this fifth embodiment and/or added to any of the other embodiments. As a second example, step 197 of the fifth embodiment of FIG. 10 may be omitted from this fifth embodiment and/or added to any of the other embodiments. As a third example, step 195 of the fifth embodiment of FIG. 10 may be omitted from this fifth embodiment and/or added to any of the other embodiments. One or more embodiments of FIGS. 6, 7, 9, and 10 may be combined.

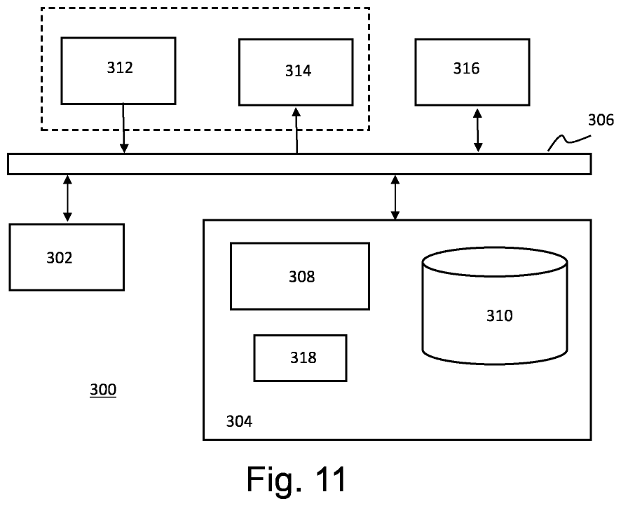

FIG. 11 depicts a block diagram illustrating an exemplary data processing system that may perform the method as described with reference to FIGS. 5-7 and 9-10.

As shown in FIG. 11, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification. The data processing system may be an Internet/cloud server, for example.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 11 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 11, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 11) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for controlling a string of light sources wrapped around an object, said system comprising:
at least one input interface;
at least one output interface; and
at least one processor configured to:
obtain, via said at least one input interface, a user input signal specifying a number of turns with which said string of light sources has been wrapped around said object,
obtain, via said at least one input interface, information indicative of a quantity of said light sources, a spacing between said light sources, and a basic shape of said object,
determine a location of each of said light sources based on said number of turns, said quantity of said light sources, said spacing between said light sources, and said basic shape of said object,
determine a light setting for each of said light sources based on said locations of said light sources, and
control, via said at least one output interface, said string of light sources according to said light settings.

2. A system as claimed in claim 1, wherein said information specifies a type of said string of light sources and said at least one processor is configured to determine said quantity of said light sources and said spacing between said light sources based on said type of said string of light sources.

3. A system as claimed in claim 1, wherein said at least one processor is configured to obtain, via said at least one input interface, part of said information from said string of light sources, said part of said information being indicative of said quantity of said light sources and said spacing between said light sources.

4. A system as claimed in claim 1, wherein said information is further indicative of a starting position of said string of light sources and said at least one processor is configured to determine said location of each of said light sources further based on said starting position, said starting position indicating whether said string of light sources has been wrapped around said object starting from a first end of said object or starting from a second end of said object.

5. A system as claimed in claim 4, wherein said user input signal is further indicative of said starting position.

6. A system as claimed in claim 1, wherein said information is further indicative of a width of said object and said at least one processor is configured to determine said location of each of said light sources further based on said width of said object.

7. A system as claimed in claim 6, wherein said user input signal is further indicative of said width of said object.

8. A system as claimed in claim 1, wherein said user input signal is further indicative of a wrapping direction of said string of light sources around said object and said at least one processor is configured to determine said light setting for each of said light sources further based on said wrapping direction, said wrapping direction being clockwise or counter clockwise.

9. A system as claimed in claim 1, wherein said user input signal is further indicative of said basic shape of said object.

10. A system as claimed in claim 1, wherein said information is further indicative of a height of said object and said at least one processor is configured to:
determine whether said height matches said number of turns,
if said height and said number of turns do not match, ask a user to provide further user input indicative of whether said string of light sources is wrapped with a higher number of turns around a top half of said object or around a bottom half of said object, and
determine said location of each of said light sources further based on said further user input.

11. A system as claimed in claim 1, wherein said at least one processor is configured to:
determine said light setting for each of said light sources based on said locations of said light sources such that light sources located on a first side of said object render a first color and light sources located on a second side of said object render a second color,
control, via said at least one output interface, said string of light sources according to said light settings,
ask a user to provide second feedback indicative of a side of said object at which said first color is being rendered, said side being one of a left side, a right side, a front side, and a back side,
determine a further light setting for each of said light sources based on said locations of said light sources and said second feedback, and
control, via said at least one output interface, said string of light sources according to said further light settings.

12. A method of controlling a string of light sources wrapped around an object, said method comprising:
obtaining, via at least one input interface, a user input signal specifying a number of turns with which said string of light sources has been wrapped around said object;
obtaining, via said at least one input interface, information indicative of a quantity of said light sources, a spacing between said light sources, and a basic shape of said object;
determining a location of each of said light sources based on said number of turns, said quantity of said light sources, said spacing between said light sources, and said basic shape of said object;
determining a light setting for each of said light sources based on said locations of said light sources; and
controlling said string of light sources according to said light settings.

13. A computer program product for a computing device, the computer program product comprising computer program code which, when the computer program product is run on the system of claim 1.
